(19) United States
(12) Patent Application Publication
(10) Pub. No.: US 2012/0171998 A1
(43) Pub. Date: Jul. 5, 2012

(54) METHOD AND APPARATUS FOR PERFORMING LOST MODE IN A MOBILE DEVICE

(75) Inventor: Sung Min KANG, Seoul (KR)

(73) Assignee: SAMSUNG ELECTRONICS CO. LTD., Suwon-si (KR)

(21) Appl. No.: 13/297,484

(22) Filed: Nov. 16, 2011

(30) Foreign Application Priority Data
Jan. 3, 2011 (KR) 10-2011-0000055

(51) Int. Cl. H04W 12/06

(52) U.S. Cl. 455/411

(57) ABSTRACT

A method and apparatus for performing a lost mode in a mobile device are provided. When the mobile device receives a communication message containing a lost notification string, a lost mode is executed. The mobile device in the lost mode is connected to a social network server, based on user authentication information previously registered in the mobile device. The mobile device transmits a lost notification message, containing information regarding a location where the mobile device is currently located, to the social network server. As a result, it is more likely that the owner of the lost mobile device can retrieve the mobile device from a person who found it.

### PRIORITY

This application claims the benefit under 35 U.S.C. §119(a) of a Korean patent application filed on Jan. 3, 2011 in the Korean Intellectual Property Office and assigned Serial No. 10-2011-0000055, the entire disclosure of which is hereby incorporated by reference.

### BACKGROUND OF THE INVENTION

1. Field of the Invention

This invention relates to systems for operating mobile devices. More particularly, the present invention relates to a method and apparatus for performing a lost mode in a mobile device.

2. Description of the Related Art

Mobile devices have been developed to provide a variety of functions, including a call function, a message transmission/reception function, a schedule function, a file playback function, and the like. Mobile devices are currently being developed to include additional functions. In addition to providing a variety of functions, mobile devices also store a large amount of data. Mobile devices perform a communication function based on the unique identification-information. Mobile devices can provide data to users. Examples of data include a call history, transmitted/received messages, schedules, voice files, video files, etc. Mobile devices store users' private information and perform a corresponding function related thereto.

However, when such mobile devices are lost, users may experience inconvenience, for example exposure of their private information. The lost mobile devices may be used by individuals who find the devices. If the lost mobile devices are locked, they may avoid exposing data contained therein, so the device cannot be used by the person who finds the device. However, although lost mobile devices may be locked, this does not ensure that they will be returned to the original users.

Accordingly, there is a need for technology that enables a lost mobile device to be easily returned to the owner, thereby preventing data from being exposed by the mobile device and preventing usage by the individual who finds the mobile device.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for performing a lost mode in a mobile terminal.

In accordance with an aspect of the present invention, a method for performing a lost mode is provided. The method includes setting a lost mode on the mobile device when receiving a communication message containing a lost notification string, connecting the mobile device in the lost mode to a social network server, based on user authentication information previously registered in the mobile device, and transmitting a lost notification message, containing information regarding a location where the mobile device is currently located, to the social network server.

In accordance with another aspect of the present invention, a method for performing a lost mode is provided. The method includes setting a lost mode on the mobile device when the mobile device receives a communication message including a lost notification string, and transmitting, when an operation command is created in the lost mode, a lost notification message, including information regarding a location where the mobile device is currently located, based on identification-information previously stored in the mobile device.

In accordance with another aspect of the present invention, an apparatus for performing a lost mode is provided. The apparatus includes a Radio Frequency (RF) communication unit for performing RF communication, a lost mode execution determining unit for setting a lost mode, when receiving a communication message including a lost notification message via the RF communication unit, and a lost mode performing unit for connecting the mobile device to a social network server via the RF communication unit, based on user authentication information previously registered, in the lost mode, and for transmitting a lost notification message, including information regarding a location where the mobile device is currently located, to the social network server.

In accordance with another aspect of the present invention, a mobile device is provided. The mobile device includes an RF communication unit for performing RF communication, a lost mode execution determining unit for setting a lost mode, when receiving a communication message including a lost notification message via the RF communication unit, and a lost mode performing unit for transmitting a lost notification message, including information regarding a location where the mobile device is currently located, based on identification-information previously stored in the mobile device, when an operation command is created in the lost mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a schematic block diagram of a mobile device according to an exemplary embodiment of the present invention;

FIG. 2 illustrates a flowchart of a method for operating a mobile device according to an exemplary embodiment of the present invention;

FIG. 3 illustrates a flowchart of a method for performing a lost mode according to an exemplary embodiment of the present invention;

FIG. 4 illustrates a flowchart of a method for performing a lost mode according to an exemplary embodiment of the present invention; and

FIG. 5 illustrates a flowchart of a method for performing a lost mode according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition description of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, the term “identification-information” refers to unique information that requires performing a communication function in a mobile device. Mobile devices are identified via their respective identification-information. Identification-information regarding mobile devices is represented as an Electronic Serial Number (ESN) used in Code Division Multiple Access (CDMA), International Mobile Equipment Identity (IMEI) used in Global System for Mobile communication (GSM), International Mobile Subscriber Identity (IMSI), etc. Mobile devices connect to a mobile communication network via their respective identification-information.

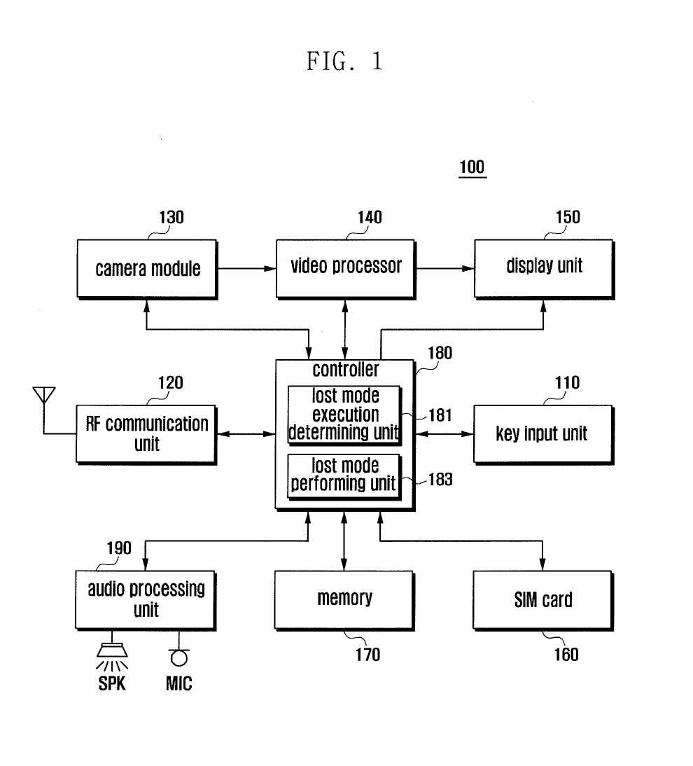

FIG. 1 illustrates a schematic block diagram of a mobile device according to an exemplary embodiment of the present invention. The mobile device may be, but is not limited to, a mobile phone.

Referring to FIG. 1, the mobile device 100 includes a key input unit 110, a Radio Frequency (RF) communication unit 120, a camera module 130, a video processor 140, a display unit 150, a Subscriber Identity Module (SIM) card 160, a memory 170, a controller 180, and an audio processing unit 190. The mobile device 100 may include additional and/or different units. Similarly, the functionality of two or more of the above units may be integrated into a single component.

The key input unit 110 includes a number of keys for inputting numbers and character information and a function keys for setting a variety of functions.

The RF communication unit 120 performs an RF communication function for the mobile device 100. The RF communication unit 120 includes an RF transmitter for up-converting the frequency of signals to be transmitted and amplifying the signals and an RF receiver for low-noise amplifying received RF signals and down-converting the frequency of the received RF signals. The RF communication unit 120 may be connected to a mobile communication network. In addition, the RF communication unit 120 may also be connected to a social network server (not shown).

The camera module 130 performs a photographing function and acquires video data. The camera module 130 includes a camera sensor and a signal processor. The camera sensor senses optical signals and converts them to electrical signals. The camera sensor may be implemented with a Charged-Coupled Device (CCD) sensor. The signal processor converts the analog video signals, output from the camera sensor, into digital video signals. In an exemplary embodiment of the invention, the signal processor is implemented with a Digital Signal Processor (DSP). The camera sensor and the signal processor may be integrally formed as one body or separately.

The video processor 140 creates screen data used to display video data on the display unit 150. The video processor 140 processes video data based on a unit of frames and outputs the frames to meet the size and features of the display unit 150. The video processor 140 includes a video codec that compresses video data according to the setting mode of the display unit 150 or decompresses the compressed video data.

The display unit 150 displays screen data corresponding to video data output from the video processor 140. The display unit 150 also displays user data output from the controller 180. The display unit 150 may be implemented with a Liquid Crystal Display (LCD). In this case, the display unit 150 includes an LCD controller, an LCD memory for storing video data, an LCD device, etc. The display unit 150 may also be implemented with a touch screen. The touch screen may also serve as an input mechanism instead of, or in addition to, the key input unit 110.

The SIM card 160 stores SIM information to support an RF communication function of the mobile device 100. SIM information includes an International Mobile Subscriber Identity (IMSI), history information related to communication, and the like. The SIM card 160 stores data according to a file system that includes a Master File (MF), a Dedicated File (DF), and an Elementary File (EF). The SIM card 160 can be detachably installed in the mobile device 100 via a card connector (not shown).

The memory 170 includes a program memory unit and data memory units. The program memory unit stores application programs to control the operations of the mobile device 100. The program memory unit may store application programs to perform a lost mode. The data memory units store data generated when the application programs are executed. The memory 170 also stores the identification-information regarding the mobile device 100. The memory 170 stores SIM information regarding the SIM card 160. The memory 170 can also store user authentication information to authenticate the connection to a social network server.

The controller 180 controls the entire operation of the mobile device 100. The controller 180 includes a data processor. The data processor includes a transmitter for coding and modulating signals to be transmitted and a receiver for demodulating and decoding received signals. For example, the data processor may include a modem and codecs. The codecs include a video codec for processing video data and an audio codec for processing audio data such as voice signals, etc.

The controller 180 allows the mobile device 100 to be connected to a mobile communication network via the identification-information. The controller 180 may use a Social Network Service (SNS). The controller 180 may be connected to a social network server via the user authentication information and communicates therewith. The controller 180 performs a lost mode. The controller 180 includes a lost mode execution determining unit 181 and a lost mode performing unit 183.

The lost mode execution determining unit 181 detects whether the mobile device 100 is lost, and determines whether to perform a lost mode. When the lost mode execution determining unit 181 receives a communication message via the RF communication unit 120, it determines whether to perform a lost mode by checking whether the communication message includes a lost notification string. When the communication message includes a lost notification string, the lost mode execution determining unit 181 concludes that a lost mode must be performed. When the SIM card 160 is installed in the card connector, the lost mode execution determining unit 181 determines whether to perform a lost mode by checking whether SIM information of the SIM card 160 is stored in the memory 170. When SIM information of the SIM card 160 is stored in the memory 170, the lost mode execution determining unit 181 concludes that a lost mode should be performed.

The lost mode performing unit 183 performs a lost mode. When the lost mode execution determining unit 181 concludes that a lost mode should be performed, the lost mode performing unit 183 performs a lost mode. The lost mode performing unit 183 sets a lock. The lost mode performing unit 183 detects information regarding a location where the mobile device 100 is currently located. The lost mode performing unit 183 connects to a social network server using user authentication information stored in the memory 170, and then transmits a lost notification message, including a location where the mobile device 100 is currently located, thereto. Alternatively, the lost mode performing unit 183 may also transmit a lost notification message, including a location where the mobile device 100 is currently located, to the other mobile devices.

The audio processing unit 190 plays back audio data, output from the audio codec of the data processor, via the speaker (SPK) or transmits audio data, received via the microphone (MIC), to the audio code.

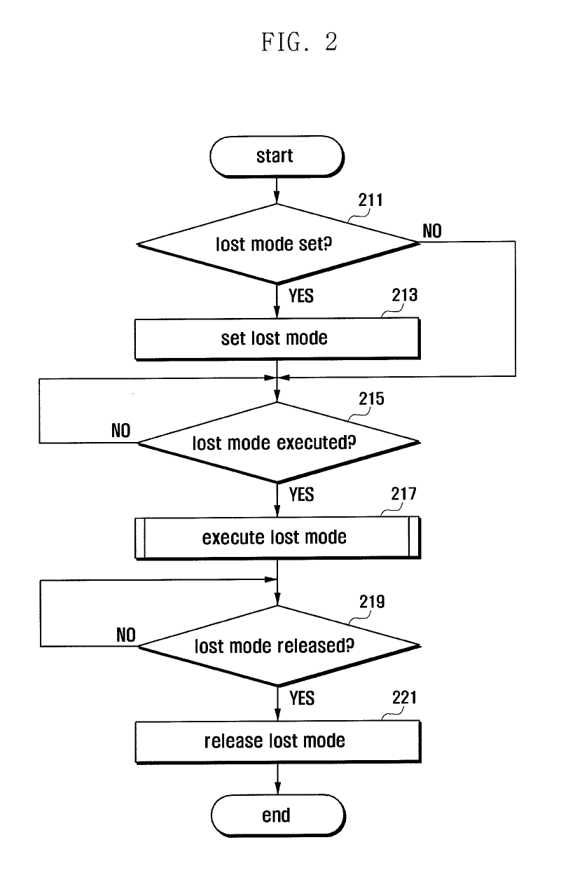

FIG. 2 illustrates a flowchart of a method for operating a mobile device according to an exemplary embodiment of the present invention.

Referring to FIG. 2, when the user of the mobile device 100 requests a process of setting a lost mode, the controller 180 senses the user's setting operation in step 211, and performs a setting process for a lost mode in step 213. Setting a lost mode may be requested by at least one of a key input signal via the key input unit 110, a touch signal via a touch screen, and transmitted audio data via the audio processing unit 190.

The controller 180 may register a lost notification string for determining whether the mobile device 100 is lost, in the memory 170. The controller 180 may also store SIM information regarding the SIM card 160, currently installed to the mobile device 100, in the memory 170. The controller 180 may store user authentication information, required for connection to a social network server, in the memory 170. The controller 180 may register identification-information regarding another mobile device in the memory 170, to allow the lost mobile device 100 to perform communication with another mobile device in a lost mode. The controller 180 may also register a lost notification message in the memory 170, which can be transmitted to a social network server or using additional identification-information in a lost mode. The controller 180 may set to lock with respect to each function in a lost mode. The controller 180 may register user identification in the memory 170, to release a lost mode.

After a lost mode is set in step 213, the controller 180 detects the determination to perform a lost mode in step 215, and performs a lost mode in step 217. When the controller 180 receives a communication message via the RF communication unit 120, the controller 180 determines whether the received communication message includes a lost notification string that was previously registered in the memory 170. When the controller 180 ascertains that the received communication message includes the lost notification string, the controller 180 performs a setting process so that a lost mode must be performed. The communication message may be received via a Short Message Service (SMS) or a Multimedia Message Service (MMS). Alternatively, when the SIM card 160 is installed in the mobile device 100 via a card connector, the controller 180 determines whether the information regarding the SIM card 160 corresponds to SIM information that was previously registered in the memory 170. When the controller 180 ascertains that the information regarding the SIM card 160 corresponds to SIM information that was previously registered in the memory 170, the controller 180 performs a setting process so that a lost mode must be performed. In addition, the controller 180 sets lock in a lost mode.

When the controller 180 detects a request for releasing a lost mode during the lost mode in step 217, the controller releases the lost mode in step 219. Releasing a lost mode may be requested by at least one of a key input signal via the key input unit 110, a touch signal via a touch screen, and transmitted audio data via the audio processing unit 190. When an operation command occurs, the controller 180 determines whether the operation command corresponds to a command to input user identification-information that was previously registered in the memory 170. When the controller 180 ascertains that the operation command corresponds to a command to input user identification-information, the controller 180 releases the lost mode in step 221. The controller 180 terminates the lost mode to release the lock. The controller 180 may allow for the use of functions that are only permitted to be used in the lost mode.

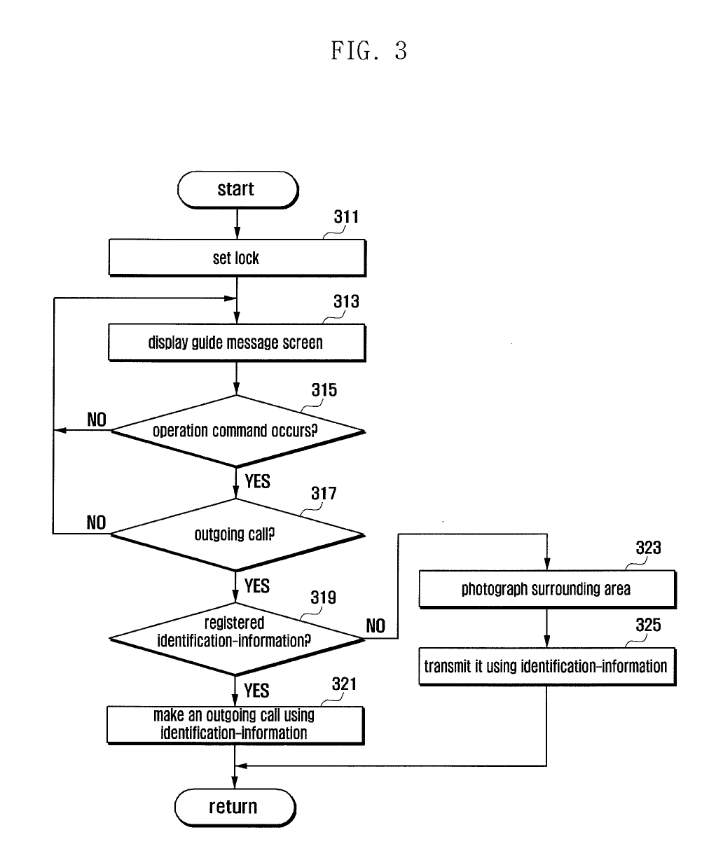

The following description provides exemplary embodiments of the process of performing a lost mode, referring to FIGS. 3 to 5. The controller 180 may perform a lost mode via one of the exemplary embodiments shown in FIGS. 3 to 5.

FIG. 3 illustrates a flowchart of a method for performing a lost mode according to an exemplary embodiment of the present invention.

Referring to FIG. 3, the controller 180 sets a lock to the mobile device 100 in step 311). When the mobile device 100 is rebooted, the controller 180 stops the operation of the mobile device 100 and restarts with an idle state, thereby setting the lock on the mobile device 100. During the lock state, the controller 180 restricts the use of preset functions. The controller 180 controls the display unit 150 to display a guide message showing screen in step 313. The guide message showing screen shows identification-information that was previously registered in the memory 170. The controller 180 may also control the display unit 150 to display a guide message including additional identification-information. An example of the guide message is ‘I lost this mobile device. Please contact me at 000-1111-2222.’

The controller 180 determines whether an operation command occurs in step 315. When the controller 180 senses an operation command in step 315, the controller 180 determines whether the operation command is to make a call (i.e., an outgoing call) in step 317. The operation command may be created by at least one of a key input signal via the key input unit 110, a touch signal via a touch screen, and transmitted audio data via the audio processing unit 190. When the controller 180 ascertains that the operation command is to make a call (i.e., an outgoing call) in step 317, the controller 180 determines whether the outgoing call is made via identification-information that was previously registered in the memory 170 in step 319. When the identification-information regarding the other user's mobile device is selected and then an operation command is created to make a call thereto, the controller 180 determines whether the other user's identification-information is identical to identification-information that was previously registered in the memory 170.

When the controller 180 does not sense an operation command in step 315, or ascertains that the operation command is not to make a call (i.e., an outgoing call) in step 317, the controller 180 reverts to and proceeds with step 313 where the controller displays a guide message showing screen including additional identification-information on the display unit 150.

When the controller 180 ascertains that the outgoing call needs to be made via identification-information that was previously registered in the memory 170 in step 319, the controller 180 makes a call using the previously registered identification-information in step 321, and then returns to step 217 of FIG. 2. When the other user's identification-information to be called is identical to the identification-information in the memory 170, the controller 180 makes a call to the other user's mobile device. This indicates that the controller 180 is operated according to the operation command.

When the controller 180 ascertains that the outgoing call does not need to be made via the identification-information that was previously registered in the memory 170 in step 319, the controller 180 photographs surrounding images via the camera module 130 in step 323. When the other user's identification-information to be called differs from the identification-information in the memory 170, the controller 180 does not make a call. This indicates that the controller 180 does not operate according to the operation command, but instead the controller 180 photographs surrounding images via the camera module irrespective of the operation command. The controller 180 transfers the captured surrounding images via the identification-information in step 325, and then returns to step 217 of FIG. 2. The controller 180 may transfer the captured surrounding images via an MMS. In addition, the controller 180 may also transfer information regarding a location where the mobile device 100 is currently located, together with the captured surrounding images.

As a result, when the mobile device 100 is lost, the mobile device 100 can restrict the use of the other functions, except for a call making function, using the identification-information. The lost mobile device 100 can protect data from exposure and prevent the mobile device from being used by an individual who finds the mobile device. The owner of the lost mobile device 100 can call the person who finds the lost mobile device 100 via another mobile device. In addition, the owner of the lost mobile device 100 can view an image of the person who found the lost mobile device 100 or the surrounding environment where the lost mobile device 100 is currently located, via another mobile device. Accordingly, it is more likely that the owner of the lost mobile device 100 can retrieve their mobile device from the person who found it.

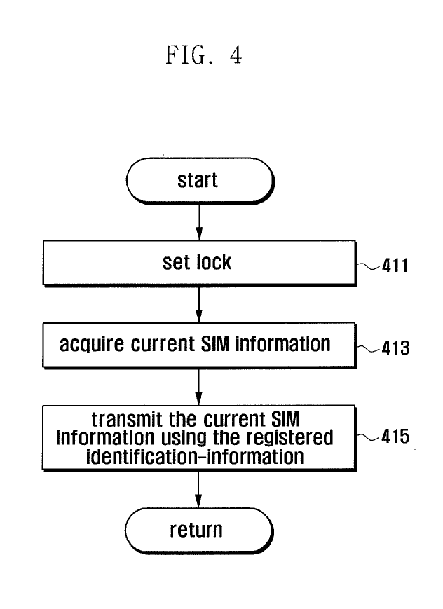

FIG. 4 illustrates a flowchart of a method for performing a lost mode according to an exemplary embodiment of the present invention.

Referring to FIG. 4, the controller 180 performs a lock process in the mobile device 100 in step 411. When the mobile device 100 is rebooted, the controller 180 stops the operations of the mobile device 100 and restarts with an idle state, thereby setting a lock on the mobile device 100. During the lock state, the controller 180 restricts the use of preset functions. The controller 180 acquires SIM information regarding the SIM card 160 that is currently installed in the mobile device 100 in step 413.

The controller 180 transfers the current SIM information via identification-information that was previously registered in the memory 170 in step 415, and then returns to step 217 of FIG. 2. The controller 180 may determine whether the current SIM information is identical to identification-information that was previously registered in the memory 170. When the controller 180 ascertains that the current SIM information differs from the identification-information that was previously registered in the memory 170, the controller 180 transfers the current SIM information. The current SIM information may be transferred via an SMS or MMS. The controller 180 may also transfer information regarding a location where the mobile device 100 is currently located, together with the current SIM information. When the controller 180 ascertains that the current SIM information is identical to the identification-information that was previously registered in the memory 170, the controller 180 does not transfer the current SIM information and instead returns to step 217 of FIG. 2.

As a result, when the mobile device 100 is lost, it is possible to restrict the use of its functions. The lost mobile device 100 can protect data from exposure and can also prevent usage by a person who finds the mobile device. The owner of the lost mobile device 100 can ascertain information regarding a person who found the lost mobile device 100 via another mobile device. Accordingly, it is more likely that the owner of the lost mobile device 100 can retrieve the device from the person who found it.

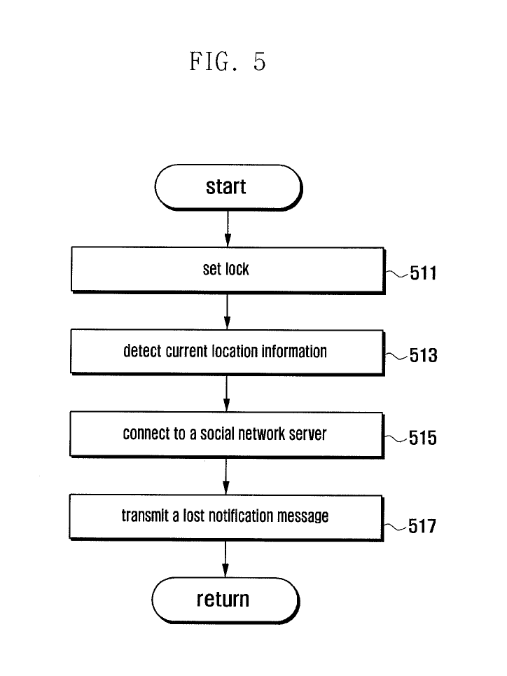

FIG. 5 illustrates a flowchart of a method for performing a lost mode according to an exemplary embodiment of the present invention.

Referring to FIG. 5, the controller 180 performs a lock process in the mobile device 100 in step 511. When the mobile device 100 is rebooted, the controller 180 stops the operations of the mobile device 100 and restarts with an idle state, thereby setting a lock on the mobile device 100. During the lock state, the controller 180 restricts the use of preset functions. The controller 180 detects information regarding a location where the mobile device 100 is currently located in step 513. For example, the controller 180 may detect a current location of the lost mobile device 100 via Global Positioning System (GPS) information. The mobile device 100 may further include a GPS receiver that receives GPS information from a GPS satellite to permit the controller 180 to detect the current location of the mobile terminal 100.

The controller 180 is connected to a social network server in step 515, via, for example, user authentication information that was previously registered in the memory 170. A social network server provides social network services, such as Cyworld, Me2 day, Facebook, Twitter, Bebo, Orkut, Meetup, and the like. User authentication information includes an Identifier (ID) and a password. The controller 180 can log in to a social network server using the user authentication information. The controller 180 transmits a lost notification message that was previously registered in the memory 170 to the social network server in step 517, and then returns to step 217 of FIG. 2. The controller 180 may transmit the current location information of the lost mobile device 100 via the lost notification message. The controller 180 may also transmit another piece of identification-information that was previously registered in the memory 170 via the lost notification message.

Although the controller 180 is described as transmitting a lost notification message to a social network server, it should be understood that exemplary embodiments of the present invention are not limited thereto. For example, the controller 180 may directly transmit a lost notification message using identification-information that was previously registered in the memory 170, step 517, without performing step 515. In that case, the controller 180 may also transmit the current location of the lost mobile device 100 via the lost notification message.

When the mobile device 100 is lost, the mobile device 100 can restrict the use of functions. The lost mobile device 100 can protect data from exposure and can also prevent the mobile device from being used by a person who finds it. In addition, the owner of the lost mobile device 100 can inform his/her friends or acquaintances of information regarding a location where the mobile device 100 is currently located, via another mobile device. Accordingly, it is more likely that the owner of the lost mobile device 100 can retrieve the mobile device form the person who found it.

The friends or acquaintances of the owner of the lost mobile device 100 can view an image of a person who found the mobile device 100 and the current location of the lost mobile device 100, via their respective mobile devices using Augmented Reality (AR) technology. Augmented Reality technology is derived from Virtual Reality technology, and serves to enhance the perception of a real-world environment. Virtual Reality technology excludes interaction with reality but only processes interaction in virtual reality that is previously constructed. On the contrary, Augmented Reality technology processes the interaction between virtual reality and reality that is previously configured, in real time. According an exemplary embodiment of the present invention, Augmented Reality technology allows the friends or acquaintances of the owner of the lost mobile device 100 to ascertain the current location of the lost mobile device 100 and the image of a person who found the mobile device 100, in reality, via their respective mobile devices. The friends or acquaintances of the owner of the lost mobile device 100 can inform the owner of the lost mobile device 100 of their ascertained information using identification-information or can directly approach the person who found the mobile device 100.

As described above, when the mobile device 100 is lost, the mobile device 100 can restrict the use of functions by setting a lock. Therefore, the lost mobile device 100 can protect data from exposure and can also prevent the mobile device from being used by a person who finds it. In addition, when the mobile device 100 is lost, it sets a lock and allows the mobile device to make a call using identification-information that was previously set. The owner of the lost mobile device 100 can contact the person who found the mobile device 100 via another mobile device. Also, when the mobile device 100 is lost, the mobile device 100 can transmit surrounding images via identification-information that was previously set, so that the owner of the lost mobile device 100 can view an image of the person who found his/her mobile device 100 or a surrounding environment at a location where the mobile device 100 is currently located, via another mobile device. When the mobile device 100 is lost, the mobile device 100 can transmit SIM information regarding a SIM card, installed to the lost mobile device 100, via identification-information that was previously set, so that the owner of the lost mobile device 100 can detect information regarding a person who found his/her mobile device 100. When the mobile device 100 is lost, the mobile device 100 can publish its current location information via a social network server.

Accordingly, although a mobile device is lost, the owner of the lost mobile device can easily recover the mobile device. The lost mobile device can protect data from exposure and can also prevent the mobile device from being used by a person who finds it.

As described above, a method and apparatus for performing a lost mode in a mobile device, according to an exemplary embodiment of the present invention, can publicly display information regarding a location where a lost mobile device is located via a social network server. This increases the possibility that the lost mobile device will be returned to its owner. Even if a mobile device is lost, the mobile device can be easily returned to the mobile device owner. Accordingly, the method and apparatus according to exemplary embodiments of the present invention can protect data in the lost mobile device and also prevent the lost mobile device from being used by the person who finds it.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for performing a lost mode in a mobile device, the method comprising:
setting a lost mode on the mobile device when receiving a communication message containing a lost notification string;
connecting the mobile device in the lost mode to a social network server, based on user authentication information previously registered in the mobile device; and
transmitting a lost notification message, containing information regarding a location where the mobile device is currently located, to the social network server.

2. The method of claim 1, wherein the setting of the lost mode comprises:
setting the lost mode on the mobile device when a Subscriber Identity Module (SIM) card with SIM information, not previously registered in the mobile device, is installed in the mobile device.

3. The method of claim 1, further comprising:
setting a lock on the mobile device in the lost mode.

4. The method of claim 3, further comprising:
displaying a guide message showing screen including identification-information previously stored in the mobile device, in the lost mode;
determining, when an operation command is created, whether the operation command is to make a call according to the identification-information; and
making the call based on the identification-information, when the operation command is to make the call.

5. The method of claim 4, further comprising:
photographing images surrounding the mobile device, when the operation command is not to make the call; and
transmitting the surrounding images based on the identification-information.

6. The method of claim 2, further comprising:
transmitting the SIM information based on identification-information previously stored in the mobile device, in the lost mode.

7. The method of claim 3, further comprising:
terminating the lost mode and releasing the lock state, when the user authentication information that was previously registered in the mobile device is input.

8. A method for performing a lost mode in a mobile device, the method comprising:
setting a lost mode on the mobile device when the mobile device receives a communication message including a lost notification string; and
transmitting, when an operation command is created in the lost mode, a lost notification message including information regarding a location where the mobile device is currently located, based on identification-information previously stored in the mobile device.

9. The method of claim 8, wherein the setting of the lost mode comprises:
setting the lost mode when a Subscriber Identity Module (SIM) card with SIM information, not previously registered in the mobile device, is installed in the mobile device.

10. The method of claim 8, further comprising:
setting a lock on the mobile device in the lost mode.

11. The method of claim 10, further comprising:
displaying a guide message showing screen including identification-information, previously stored in the mobile device, in the lost mode;
determining, when an operation command is created, whether the operation command is to make a call according to the identification-information; and
making the call using the identification-information, when the operation command is to make the call.

12. The method of claim 10, further comprising:
terminating the lost mode and releasing the lock state, when the user authentication information that was previously registered in the mobile device is input.

13. An apparatus for performing a lost mode in a mobile device, the apparatus comprising:
a Radio Frequency (RF) communication unit for performing RF communication;
a lost mode execution determining unit for setting a lost mode, when receiving a communication message including a lost notification message via the RF communication unit; and
a lost mode performing unit for connecting the mobile device to a social network server via the RF communication unit, based on user authentication information previously registered, in the lost mode, and for transmitting a lost notification message, including information regarding a location where the mobile device is currently located, to the social network server.

14. The apparatus of claim 13, further comprising:
a card connector to which a SIM card is detachably installed,
wherein the lost mode execution determining unit sets the lost mode to the mobile device, when a Subscriber Identity Module (SIM) card with SIM information, not previously registered in the mobile device, is installed in the card connector.

15. The apparatus of claim 13, wherein the lost mode performing unit sets a lock on the mobile device in the lost mode.

16. The apparatus of claim 15, further comprising:
a display unit for displaying a guide message including identification-information previously stored in the mobile device, in the lost mode, under the control of the lost mode performing unit,
wherein the lost mode performing unit determines, when an operation command is created, whether the operation command is to make a call according to the identification-information, and makes the call based on the identification-information via the RF communication unit, when the operation command is to make the call.

17. The apparatus of claim 16, further comprising:
a camera module for photographing images surrounding the mobile device, under the control of the lost mode performing unit,
wherein the lost mode performing unit allows the camera module to photograph images surrounding the mobile device, when the operation command is not to make the call, and transmits the surrounding images using the identification-information via the RF communication unit.

18. The apparatus of claim 14, wherein the lost mode performing unit transmits the SIM information based on identification-information, previously stored in the mobile device, in the lost mode, via the RF communication unit.

19. The apparatus of claim 15, wherein the lost mode performing unit terminates the lost mode and releases the lock state, when the user authentication information previously registered in the mobile device is input.

20. A mobile device, comprising:
a Radio Frequency (RF) communication unit for performing RF communication;
a lost mode execution determining unit for setting a lost mode, when receiving a communication message including a lost notification message via the RF communication unit; and
a lost mode performing unit for transmitting a lost notification message, including information regarding a location where the mobile device is currently located, based on identification-information previously stored in the mobile device, when an operation command is created in the lost mode.

21. The mobile device of claim 20, further comprising:
a card connector to which a SIM card is detachably installed,
wherein the lost mode execution determining unit sets the lost mode to the mobile device, when a Subscriber Identity Module (SIM) card with SIM information, not previously registered in the mobile device, is installed to the card connector.

22. The mobile device of claim 20, wherein the lost mode performing unit sets a lock on the mobile device in the lost mode.

23. The mobile device of claim 22, further comprising:
a display unit for displaying a guide message including identification-information previously stored in the mobile device, in the lost mode, under the control of the lost mode performing unit,
wherein the lost mode performing unit determines, when an operation command is created, whether the operation command is to make a call according to the identification-information, and makes the call based on the identification-information via the RF communication unit, when the operation command is to make the call.

24. The mobile device of claim 22, wherein the lost mode performing unit terminates the lost mode and releases the lock state, when user authentication information previously registered in the mobile device is input.
